(19) United States
(12) Patent Application Publication
(10) Pub. No.: US 2018/0022268 A1
(43) Pub. Date: Jan. 25, 2018

(54) LED CAR LIGHT

(71) Applicant: Shenzhen Aurora Technology Co., Ltd., Shenzhen (CN)

(72) Inventor: Qingbo XIE, Shenzhen (CN)

(21) Appl. No.: 15/226,632

(22) Filed: Aug. 2, 2016

(30) Foreign Application Priority Data
Jul. 22, 2016 (CN) 201620783638.1

(51) Int. Cl. B60Q 1/26; F21V 15/015; F21V 19/00; F21V 17/02; F21S 8/10; B60Q 1/00

(52) U.S. Cl. CPC B60Q 1/26; F21S 48/328; B60Q 1/0088; F21V 19/005; F21S 48/2212; F21V 17/02; F21V 15/015; F21Y 2115/10

(57) ABSTRACT

The present application relates to the technical field of lighting devices, and provides an LED car light which comprises an outer shell, two support components, a master control circuit board and a lighting lamp group, the lighting lamp group comprises a plurality of LED lighting lamp beads welded on the master control circuit board equidistantly and a plurality of illumination light cup components that are arranged side by side on the master control circuit board and cover the plurality of LED lighting lamp beads respectively; the outer shell is further provided with a plurality of background lights, the background lights and the lighting lamp group are arranged side by side in the outer shell, each of the background lights comprises a plurality of first LED background light beads welded on the master control circuit board and a background light cup that is arranged on the master control circuit board and covers the plurality of LED background light beads. In the LED car light provided by the present application, a plurality of background lights are added in the outer shell, and LED lighting lamp beads and the first LED background light beads are all electrically connected to the master control circuit board; in this way, besides the strong light emitted by the lighting lamp group, soft background light emitted by the background lights can also be provided, such that color temperatures of the light sources of the LED car light are abundant.

### TECHNICAL FIELD

The present application relates to the technical field of lighting apparatus, and more particularly, relates to an LED car light.

### BACKGROUND

LED is the abbreviation of Light Emitting Diode, a basic structure of an LED is a piece of electroluminescent semiconductor material chip, which is solidified on a support by elargol or white glues, and then silver wires or gold wires are used to connect the chip with a circuit board, finally, the LED are sealed by epoxy resin so as to provide a function of protecting inner chips and wires. Therefore, the LED has a good shakeproof performance, and an application field of the LED relates to aspects of mobile phones, table lamps, household appliances, and so on.

An LED car light comprises a light cup having a light collecting function and LED light beads arranged in the light cup, by the light collecting function of the light cup, lights scattered by the LED light beads can be converged at a light emitting opening of the light cup, thereby implementing an illumination function. However, a light source of an existing LED car light has a single color temperature and a low fatigue resistance, and lacks a background light source.

### BRIEF SUMMARY

In conclusion, a purpose of the present application is providing an LED car light, which is aimed at solving a problem that a light source of an existing LED car light has a single color temperature and lacks a background light.

The present application is realized as follows: an LED car light, comprising an outer shell, two support components arranged at two sides of the outer shell, a master control circuit board and a lighting lamp group that are installed in the outer shell; the lighting lamp group comprises a plurality of LED lighting lamp beads welded on the master control circuit board equidistantly, and a plurality of illumination light cup components which are mounted side by side on the master control circuit board and cover the plurality of LED lighting lamp beads respectively; wherein the LED car light further comprises a plurality of background lights mounted in the outer shell and arranged side by side relative to the lighting lamp group, each of the background lights comprises a plurality of first LED background light beads welded on the master control circuit board and a background light cups arranged on the master control circuit board and covering the plurality of first LED background light beads.

Specifically, the background light cup comprises a first cup body, the first cup body is provided with a first cup mouth mounted on the master control circuit board and a second cup mouth configured to allow light sources of the plurality of first LED background light beads to emit light, a cup diameter of the first cup body increases gradually from the first cup mouth to the second cup mouth, and the first cup mouth covers the first LED background light beads.

Specifically, each of the illumination light cup components comprises a fixing plate and a plurality of second cup bodies that are arranged in a matrix on the fixing plate, each of the second cup bodies comprises a third cup mouth mounted on the master control circuit board and a fourth cup mouth configured to allow light sources of the plurality of LED lighting lamp beads to emit light, and the third cup mouth covers the LED lighting lamp beads.

Furthermore, the outer shell comprises a shell body configured for receiving the lighting lamp group and the background lights therein, a fixing frame located on the shell body and arranged above the lighting lamp group and the background lights, and a covering plate arranged in the fixing frame; the master control circuit board is arranged at an inner side of a bottom of the shell body.

Specifically, the fixing frame is in threaded connection with a top part of a lateral wall of the shell body by two fixing members, each of the fixing members comprises a base body, a lateral edge of the base body extends vertically and upwardly and then bends downwardly so as to form a snap-fit connection part that is snap-fitted with the fixing frame, two lateral walls of the shell body extend horizontally and form support parts configured for supporting the fixing frame.

Specifically, the top part of the lateral wall of the shell body is concaved inwardly to form a groove configured for allowing a screw to be screwed therein, and a side of the base body facing the groove protrudes and extends vertically and downwardly to form a limiting bulge that matches with the groove.

Furthermore, an outer side of the bottom of the shell body forms a plurality of heat dissipation rib plates extending vertically and being parallel to each other.

Furthermore, the LED car light further comprises a plurality of second LED background light beads, the LED background light beads are arranged on the master control circuit board equidistantly, and are located at an outer side of a back of the illumination light cup components.

Furthermore, each of the support components comprises a connecting member fixedly connected with one side of the outer shell and a support base arranged at an outer side of the connecting member and being rotatable relative to the connecting member.

Furthermore, the LED car light further comprises a damping member configured for limiting rotations of the support base relative to the connecting member, each of the damping members is arranged between the support base and the connecting member.

Compared with the prior art, in the LED car light provided by the present application, the plurality of background lights arranged side by side relative to the lighting lamp group are added in the outer shell, and the LED lighting lamp beads and the first LED background light beads are all electrically connected to the master control circuit board; in this way, besides the strong light emitted by the lighting lamp group, soft background light emitted by the background lights can also be provided, such that color temperatures of the light sources of the LED car light are abundant, and the LED car light can be applicable to various environments.

### BRIEF DESCRIPTION OF THE DRAWINGS

FIG. 1 illustrates a disassembled view of an LED car light provided by an embodiment of the present application;

FIG. 2 illustrates a structural schematic view of the LED car light provided by the embodiment of the present application;

FIG. 3 illustrates a cut-away view of the portion A shown in FIG. 2;

FIG. 4 illustrates an enlarged view of the portion B shown in FIG. 3;

FIG. 5 illustrates a disassembled view of a lighting lamp group and background lights provided by the embodiment of the present application;

FIG. 6 illustrates a structural schematic view of a background light cup provided by the embodiment of the present application;

FIG. 7 illustrates a structural schematic view of an illumination light cup component provided by the embodiment of the present application.

### DETAILED DESCRIPTION OF THE PREFERRED EMBODIMENT

In order to make the purpose, the technical solution and the advantages of the present application be more clear, the present application will be further described in detail hereinafter with reference to accompanying drawings and embodiments. It should be understood that the specific embodiments described herein are used to illustrate the present application merely, rather than limiting the present invention.

It needs to be noted that, when one component is described as “fixed to” or “mounted on” another component, this component can be located on another component directly or indirectly. When one component is described as “connected with” another component, this component can be connected with another component directly or indirectly.

It needs to be further noted that, position terms in these embodiments, such as left, right, up, down, top, bottom, and so on, are only mutual relative concepts or take a normal using state of a product as reference, and should not be regarded as being restrictive.

An implementation of the present application will be described in detail hereinafter with reference to the specified embodiments.

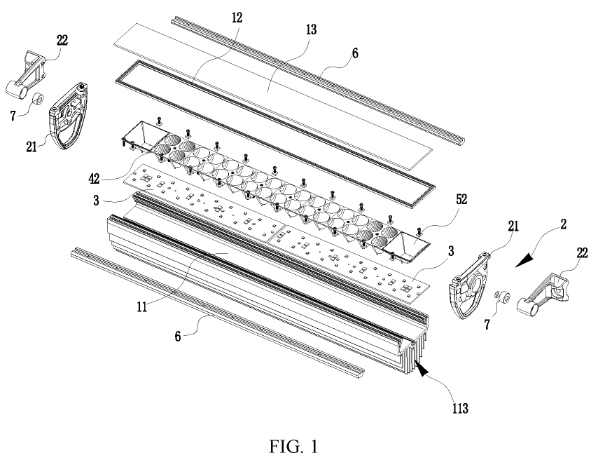

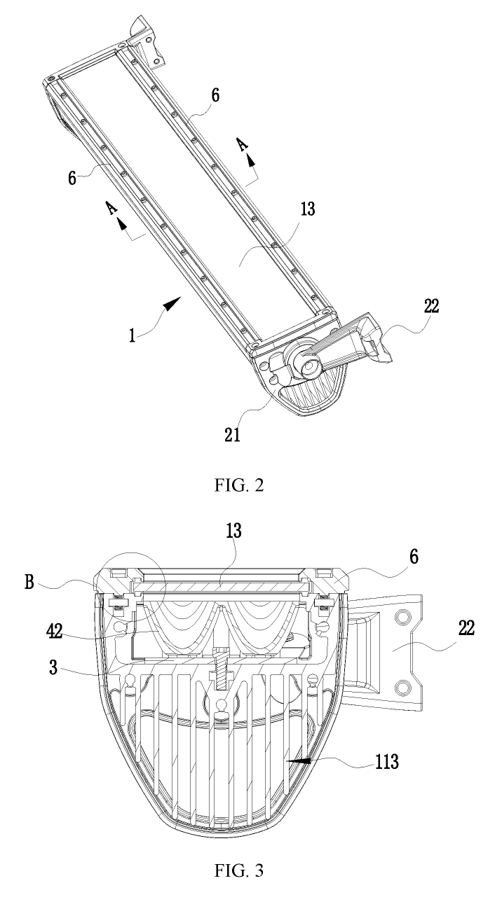

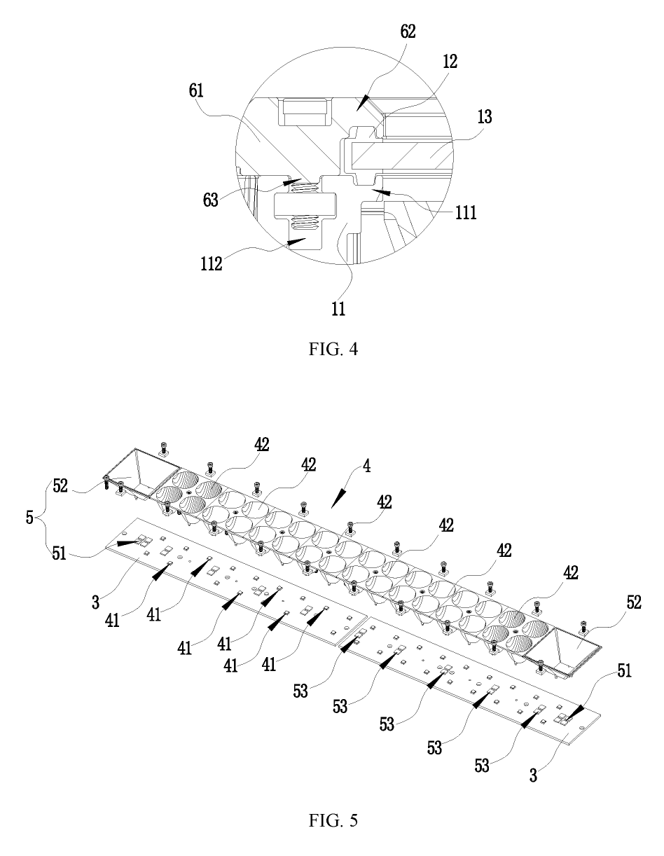

Please refer to FIGS. 1-5, an LED (Light Emitting Diode) car light provided by one embodiment of the present application comprises an outer shell 1, two support components 2 arranged at two sides of the outer shell 1, and a master control circuit board 3 and a lighting lamp group 4 that are received in the outer shell 1; the lighting lamp group 1 comprises a plurality of LED lighting lamp beads 41 welded on the master control circuit board 3 equidistantly and a plurality of illumination light cup component 42 arranged side by side on the master control circuit board 3 and covering the LED illumination light cup beads 41 respectively, the outer shell 1 is further provided therein with a plurality of background lights 5, the background lights 5 and the lighting lamp group 4 are arranged side by side, and each of the background lights 5 comprises a plurality of first LED background light beads 51 welded on the master control circuit board 3 and a background light cup 52 arranged on the master control circuit board 3 and covering the first LED background light beams 51.

In the LED car light provided by the embodiment of the present application, the plurality of background lights 5 arranged side by side relative to the lighting lamp group 4 are added in the outer shell 1, and the LED lighting lamp beads 41 and the first LED background light beads 51 are all electrically connected to the master control circuit board 3, in this way, besides the strong light emitted by the lighting lamp group 4, soft background lights emitted by the background lights 5 can also be provided, such that color temperatures of the light sources of the LED car light are abundant, and the LED car light can be applicable to various environments. At the same time, the background lights 5 can be lightened independently with respect to the lighting lamp group 4, in this way, the background lights 5 can be used as warning lights or decorative lights.

It needs to be noted that, the number and the positions of the background lights 5 are not limited, the background lights 5 and the lighting lamp group 4 can be arranged side by side in the outer shell 1, for example, the background lights 5 are located at two sides of the lighting lamp group 4 side by side; meanwhile, each of the background lights 5 and the lighting lamp group 4 can provide illumination independently and will not interfere each other.

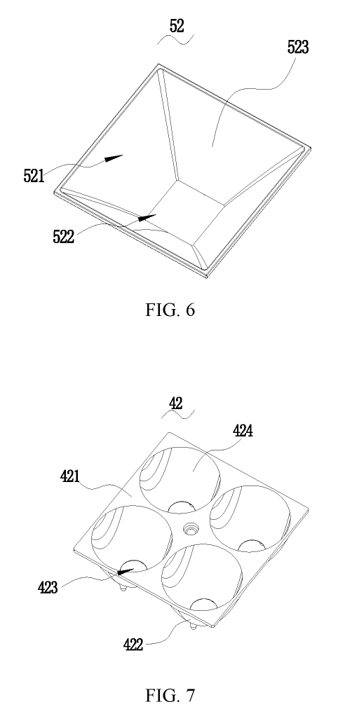

Specifically, please refer to FIG. 5 and FIG. 6, in this embodiment, the background light cup 52 comprises a first cup body 521, the first cup body 521 comprises a first cup mouth 522 mounted on the master control circuit board 3 and a second cup mouth 523 configured to allow light sources of the first LED background light beads 51 to emit light, both the first cup mouth 522 and the second cup mouth 523 are rectangle-shaped, a cup diameter of the first cup body 521 increases gradually from the first cup mouth 522 to the second cup mouth 523; moreover, the first cup mouth 522 covers the first LED background light beads 51. Since a cup wall of the first cup body 521 is flat and has no curvature radian, light emitted from the first LED background light beads 51 located at the first cup mouth 522 can't be focused in the first cup body 521, but is scattered outwardly from the second cup mouth 523 through the cup wall; therefore, the background lights 5 have soft light sources, and have excellent fatigue resistance. Preferably, an outer side of the first cup body 521 is provided with a plurality of locating posts (not shown in the figures) extending vertically in a direction that faces the master control circuit board 3, by using the locating posts, positioning and connection of the first cup body 521 and the master control circuit board 3 are realized by the locating posts.

Specifically, please refer to FIG. 5 and FIG. 7, in this embodiment, each of the illumination light cup components 42 comprises a fixing plate 421 and a plurality of second cup bodies 422 that are arranged in a matrix on the fixing plate 421, each of the second cup bodies 422 has a third cup mouth 423 mounted on the master control circuit board 3 and a fourth cup mouth 424 provided to allow the light sources of the LED lighting lamp beads 41 to emit light, the third cup mouth 423 and the fourth cup mouth 424 are all round-shaped; a cross section of the second cup body 422 along a shaft diameter direction is arc-shaped; moreover, the third cup mouth 423 covers the LED lighting lamp beads 41. Preferably, the fixing plate 421 is provided therein with four second cup bodies 422 arranged in matrix, a third cup mouth 423 of each of the second cup bodies 422 corresponds to an LED lighting lamp bead 41, under the light collecting function of the cup wall of the second cup body 422, the lighting lamp group 4 possesses a strong light source and a good penetration performance; an inner side of the fixing plate 421 extends towards the master control circuit board 3 to form mounting pins (not shown in the figures), by screwing screws into the mounting pins, a fixed connection between the illumination light cup component 42 and the master control circuit board 3 can be achieved.

Furthermore, please refer to FIGS. 1-4, in this embodiment, the outer shell 1 comprises a shell body 11 configured for receiving the lighting lamp group 4 and the background lights 5, a fixing frame 12 located on the shell body 11 and arranged above the lighting lamp group 4 and the background lights 5, and a covering plate 13 arranged in the fixing frame 12, wherein, the covering plate 13 can be a PC (Printed Circuit) board having light permeability; the master control circuit board 3 is arranged at an inner side of the bottom of the shell body 11. Specifically, the fixing frame 12 is in threaded connection with a top part of a lateral wall of the shell body 11 by two fixing members 6; each of the fixing members 6 comprises a body 61, a lateral edge of the body 61 extends vertically and upwardly and is then bent downwardly to form a snap-fit connection part 62 configured for snapping in the fixing frame 12, two lateral walls of shell body 11 extend horizontally to form a support part 111 configured for supporting and fixing the fixing frame 12. In this way, the fixing frame 12 is placed on the supporting part 111 firstly, and then the snap-fit connection part 62 of the fixing member 6 is used to snap-fitted with the fixing frame 12, so that a fixing position is determined. Specifically, a top part of a lateral wall of the shell body 11 is concaved inwardly to form a groove 112 configured for allowing a screw to be screwed therein, a side of the body 61 facing the grooves 112 protrudes and extends vertically and downwardly to form a limiting bulge 113 that matches with the groove 112. The limiting bulge 113 is snap-fitted into the groove 112 to determine mounting positions of the fixing members 6, and then the snap-fit connection part 62 of the fixing member 6 is snap-fitted into the fixing frame 12 firmly by screw fixation.

Furthermore, unshown in the figures, an outer side of the covering plate 13 corresponding to the background lights 5 is provided with patterns. When the background lights 5 are lightened, lights of the light sources penetrate the patterns and generate different projection effects, in this way, a functional diversification of the LED car light can be implemented.

Furthermore, please refer to FIGS. 1-4, in this embodiment, an outer side of a bottom of the shell body 11 where the master control circuit board 3 is mounted is provided with a plurality of heat dissipation rib plates 113 extending vertically and being parallel to each other. The master control circuit board 3 is a main heating component in the whole illumination system, and the master control circuit board 3 is in tight contact with the bottom of the shell body 11, heat sources generated by the master control circuit board 3 are rapidly dissipated through the heat dissipation rib plates 113 at the outer side of the bottom of the shell body 11, thereby ensuring a normal working temperature of the master control circuit board 3.

Furthermore, please refer to FIG. 5, in this embodiment, the LED car light further comprises a plurality of second LED background light beads 53, the background light beads 42 are arranged on the master control circuit board 3 equidistantly and located at an outer side of a back of the illumination light cup component 42. The second LED background light beads 53 can provide illumination independently, and when the second LED background light beads 53 and the first LED background light beads 51 are lightened simultaneously, light sources of the second LED background light beads 53 emits light from the back of the illumination light cup component 42, thereby making light colors of the background light sources be more soft.

Furthermore, please refer to FIG. 1, in this embodiment, each of the two support components 2 comprises a connecting member 21 fixedly connected to a side of the outer shell 1 and a support base 62 arranged at an outer side of the connecting member 21 and being rotatable relative to the connecting member 21. Specifically, a shape of the connecting member 21 is identical to a shape of a side of the shell body 11, and the connecting member 21 is fixed to one of the two sides of the shell body 11 by screws. The LED car light further comprises a damping member 7 configured for limiting rotations of the support base 62 relative to the connecting member 21. In this way, after the connecting member 21 is rotated relative to the support base 62, it can hover stably and thereby maintaining a needed rotation angle.

The aforementioned embodiments are only preferred embodiments of the present application, and should not be regarded as being any limitation to the present application. Any modification, equivalent replacement, improvement, and so on made within the spirit and the principle of the present invention should be included within the protection scope of the present application.

1. An LED car light, comprising an outer shell, two support components arranged at two sides of the outer shell, a master control circuit board and a lighting lamp group that are installed in the outer shell; wherein, the lighting lamp group comprises a plurality of LED lighting lamp beads welded on the master control circuit board equidistantly, and a plurality of illumination light cup components which are mounted side by side on the master control circuit board and cover the plurality of LED lighting lamp beads respectively, wherein the LED car light further comprises a plurality of background lights mounted in the outer shell and arranged side by side relative to the lighting lamp group, each of the background lights comprises a plurality of first LED background light beads welded on the master control circuit board and background light cups arranged on the master control circuit board and covering the plurality of first LED background light beads.

2. The LED car light according to claim 1, wherein, the background light cup comprises a first cup body, the first cup body is provided with a first cup mouth mounted on the master control circuit board and a second cup mouth configured to allow light sources of the plurality of first LED background light beads to emit light, a cup diameter of the first cup body increases gradually from the first cup-mouth to the second cup-mouth, and the first cup mouth covers the first LED background light beads.

3. The LED car light according to claim 1, wherein, each of the illumination light cup components comprises a fixing plate and a plurality of second cup bodies that are arranged in matrix on the fixing plate, each of the second cup bodies comprises a third cup mouth mounted on the master control circuit board and a fourth cup mouth configured to allow the light sources of the plurality of LED lighting lamp beads to emit light, and the third cup mouth covers the LED lighting lamp beads.

4. The LED car light according to claim 1, wherein, the outer shell comprises a shell body configured for receiving the lighting lamp group and the background lights therein, a fixing frame located on the shell body and arranged above the lighting lamp group and the plurality of background lights, and a covering plate arranged in the fixing frame, the master control circuit board is arranged at an inner side of a bottom of the shell body.

5. The LED car light according to claim 4, wherein, the fixing frame is in threaded connection with a top part of a lateral wall of the shell body by two fixing members, each of the fixing members comprises a base body, a lateral edge of the body extends vertically and upwardly, and then bends downwardly to form a snap-fit connection part that is snap-fitted with the fixing frame, two lateral walls of the shell body extend horizontally and form support parts configured for supporting the fixing frame.

6. The LED car light according to claim 5, wherein, the top part of the lateral wall of the shell body is concaved inwardly to form a groove configured for allowing a screw to be screwed therein, and a side of the base body facing the groove extends vertically and downwardly to form a limiting bulge that matches with the groove.

7. The LED car light according to claim 4, wherein, an outer side of the bottom of the shell body forms a plurality of heat dissipation rib plates extending vertically and being parallel to each other.

8. The LED car light according to claim 1, further comprising a plurality of second LED background light beads, the LED background light beads are arranged on the master control circuit board equidistantly and are located at an outer side of a back of the illumination light cup components.

9. The LED car light according to claim 1, wherein, each of the support components comprises a connecting member that is fixedly connected with one side of the outer shell, and a support base arranged at an outer side of the connecting member and being rotatable relative to the connecting member.

10. The LED car light according to claim 9, further comprising a damping member configured for limiting rotations of the support base relative to the connecting member, each of the damping members is arranged between the support base and the connecting member.
